(19) United States
(12) Patent Application Publication
(10) Pub. No.: US 2006/0272190 A1
(43) Pub. Date: Dec. 7, 2006

(54) Information display arrangement

(76) Inventor: Shahara Khaleque, Hayes (GB)

Correspondence Address: JOHN V STEWART, 1308 HENRY BALCH DRIVE, ORLANDO, FL, 32810, US

(21) Appl. No.: 10/554,978

(22) PCT Filed: May 5, 2004
(86) PCT No.: PCT/GB04/01930

§ 371 Date: Oct. 28, 2005

(30) Foreign Application Priority Data
May 7, 2003 (GB) 0310393.4
Dec. 24, 2003 (GB) 0329939.3

(51) Int. Cl. G09F 3/18

(52) U.S. Cl. 40/661.09; 206/459.1

(57) ABSTRACT

An information display arrangement comprises a plurality of pockets (10). Each pocket has a front panel and a back panel. At least one edge (22) of each pocket is open so that a piece (26) of writing material can be inserted into that pocket. Each front panel is sufficiently transparent to enable such a piece of writing material in the respective pocket to be seen through the front panel from the outside. The pockets are held edge-to-edge in a strip (12) in such a way that one or more of the pockets can be readily separated from the remainder of the strip. The back of the strip is self-adhesive to enable the pocket(s) separated from the strip to be adhered to a surface. In use, one or more pockets can be separated from the strip and stuck to a surface such as the surround of a computer monitor, a telephone hand-set or body, or a drawer front, where the pocket can remain permanently or semi-permanently. When it is desired to make a note of something, such as a name, telephone number or task, the note can be written on one side of a piece of writing material of a size that can be inserted into the pocket, and the piece of writing material can then be inserted into the pocket so that the note can be seen through the front panel of the pocket. When that note is no longer needed and a note needs to be made of something else, the piece of writing material can be taken out of the pocket, and the further note can be written on a fresh piece of writing material which is then inserted into the pocket; alternatively, if the back of the existing piece is blank, the further note can be written on the back of the existing piece of writing material, which can then be re-inserted into the pocket back-to-front. It is envisaged that, in most cases, a pocket will be re-used for many notes, and so a degree of care in sticking a pocket neatly to a surface needs to be taken only once for all of the notes that are subsequently written for that pocket to be neatly displayed. The pockets are initially provided in a strip so that they can be neatly kept for example in a desk drawer before use.

This invention relates to arrangements to facilitate the display of information.

Sticky notes, such as Post-it® notes, provide a well-known means for storing and displaying information temporarily. Although very useful, they are often scribbled on and stuck haphazardly, for example, around computer monitors or on telephone handsets or bodies, especially in the office. The note itself is often shaped such that it needs to be trimmed or folded to fit neatly around a monitor or on a telephone, and the stickiness can fail after a while, especially if the note is kept for any length of time, for example to hold a telephone number for a current client.

The present invention is a development of sticky notes which aims to benefit from some of their advantages but not suffer from some of their disadvantages.

In accordance with the present invention, there is provided an information display arrangement comprising a plurality of pockets, each pocket having a front panel and a back panel, at least one edge of each pocket being open so that a piece of writing material can be inserted into that pocket, each front panel being sufficiently transparent to enable such a piece of writing material in the respective pocket to be seen through the front panel from the outside, the pockets being held edge-to-edge in a strip in such a way that one or more of the pockets can be readily separated from the remainder of the strip, and the back of the strip being self-adhesive to enable the pocket(s) separated from the strip to be adhered to a surface. In use, one or more pockets can be separated from the strip and stuck to a surface, such as the surround of a computer monitor, a telephone handset or body, or a drawer front, where the pocket can remain permanently or semi-permanently. When it is desired to make a note of something, such as a name, telephone number or task, the note can be written on one side of a piece of writing material of a size that can be inserted into the pocket, and the piece of writing material can then be inserted into the pocket so that the note can be seen through the front panel of the pocket. When that note is no longer needed and a note needs to be made of something else, the piece of writing material can be taken out of the pocket, and the further note can be written on a fresh piece of writing material which is then inserted into the pocket; alternatively, if the back of the existing piece is blank, the further note can be written on the back of the existing piece of writing material, which can then be re-inserted into the pocket back-to-front. It is envisaged that, in most cases, a pocket will be re-used for many notes, and so a degree of care in sticking a pocket neatly to a surface needs to be taken only once for all of the notes that are subsequently written for that pocket to be neatly displayed. The pockets are initially provided in a strip so that they can be neatly kept for example in a desk drawer before use and, in some embodiments of the invention, for another reasons that will be described below.

In a first embodiment of the invention, the pockets are separately formed and the arrangement further includes a continuous backing layer to which the pockets are adhered edge-to-edge by their self-adhesive backs, each pocket being peelable from the backing layer to expose the self-adhesive back of that pocket. The backing layer therefore serves not only to protect the self-adhesive backs of the pockets before use so that the pockets do not become stuck unintentionally to surfaces they come in contact with and so that the self-adhesive backs do not become soiled with dust and dirt, but also to hold the pockets together neatly in a strip before they are used.

In this case, the backing layer is preferably tearable between adjacent pockets (and may have perforation lines to facilitate tearing in a straight line) and is foldable. Not only does this mean that, after one or more pockets have been removed from the end of the strip, the defunct portion of the backing layer for those pockets can be torn off and disposed of, but also if it is desired to stick a block of aligned pockets to a surface, those pockets can be torn off from the strip as a block complete with their portion of the backing layer, the backing layer can then be peeled partly back and folded to expose part of the self-adhesive back of each pocket in the block, the pockets can then be partially stuck as a block to the surface, and then removal of the backing layer can be completed and the pockets can be completely stuck to the surface. Although this may be somewhat fiddly, it enables the pockets to be applied to the surface aligned as a block without the need manually to align the pockets individually.

In a second embodiment, the pockets are integrally formed with each other in the strip with means (such as score lines or perforation lines) defining lines between adjacent pockets along which those adjacent pockets can be readily separated. Not only do the pockets therefore hold themselves together neatly in a strip before they are used, but also a block of pockets can be separated from the reminder of the strip and stuck to a surface while the pockets of the block are still holding themselves together in neat alignment.

In one version of the second embodiment, the strip is flexible and is readily tearable along the separation lines. In another version of the second embodiment, the back panels are integrally formed and are sufficiently brittle that they can readily be snapped apart along the separation lines.

The arrangement of the second embodiment may further include a continuous backing layer covering the self-adhesive back of the strip, the backing layer being tearable along the separation lines and being peelable from the separated pocket(s) to expose the self-adhesive back(s) of the separated pocket(s). The backing layer therefore serves to protect the self-adhesive backs of the pockets before use so that the pockets do not become stuck unintentionally to surfaces they come in contact with and so that the self-adhesive backs do not become soiled with dust and dirt. When one or more pockets are separated from the end of the strip, they can be removed complete with their portion of the backing layer which can then be peeled from those pockets and disposed of, or the pockets can be peeled from the backing layer as they are removed, and subsequently the defunct portion of the backing layer for those pockets can be torn off and disposed of.

Alternatively, the arrangement of the second embodiment may further include a series of backing pieces each covering the self-adhesive back of a respective one of the pockets, each backing piece being peelable from the respective pocket to expose the self-adhesive back of the respective pocket. The backing pieces therefore serve to protect the self-adhesive backs of the pockets before use so that the pockets do not become stuck unintentionally to surfaces they come in contact with and so that the self-adhesive backs do not become soiled with dust and dirt. In this case, each backing piece may be a piece of writing material of a size such that it can be inserted into the respective pocket. Accordingly, when a pocket is first used, a suitable piece of writing material is readily to hand.

The pockets may each be of any desired shape and arranged in the strip in any desired manner, but are preferably generally rectangular and arranged longer-edge to longer-edge in the strip and/or with one of their shorter edges open.

The arrangement may further include a further such strip held together with and readily separable from the first-mentioned strip. In this case, the pockets of the first strip might be of a different length to those of the second strip.

The arrangement may be provided as a set in combination with a plurality of pieces of writing material (for example of paper, card or plastics material), or a sheet that can readily be divided up into a plurality of pieces of writing material, each of which can be written on (for example by pen or pencil) and inserted into one of the pockets.

Specific embodiments of the present invention will now be described, purely by way of example, with reference to the accompanying drawings, in which:

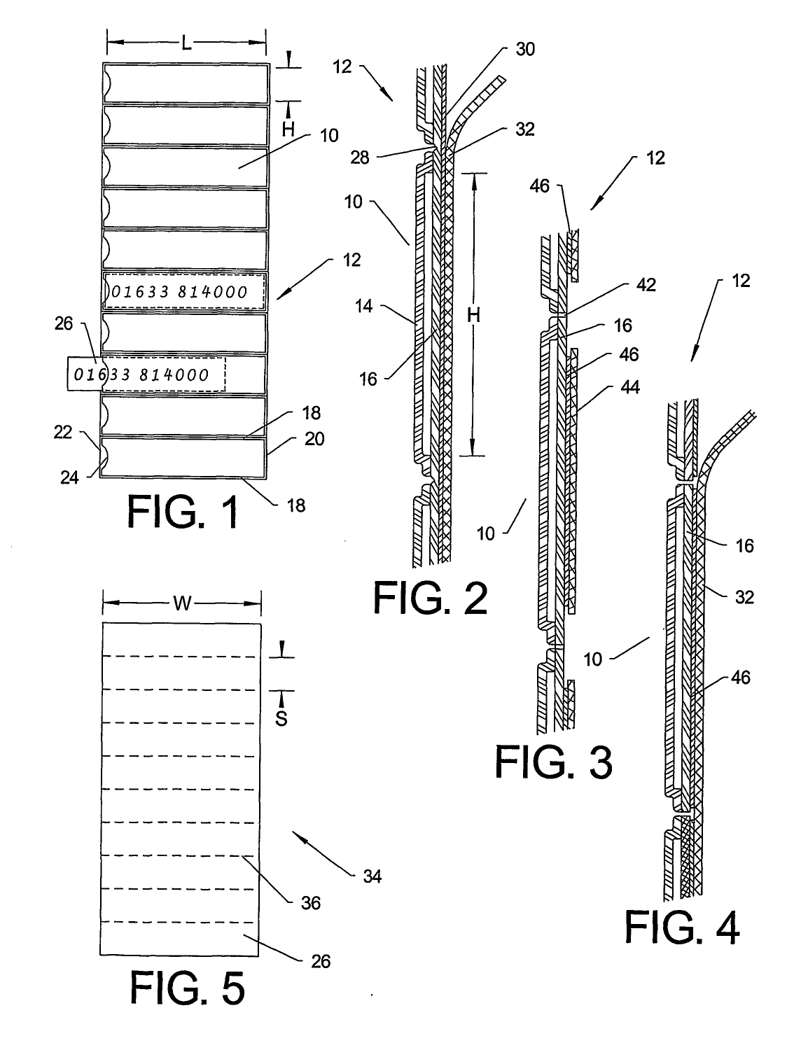

FIG. 1 is a face view of a strip of pockets with one insert card fully inserted into one of the pockets and another insert card partly inserted into another pocket;

FIG. 2 is a sectioned side view, taken along the section line S-S in FIG. 1 and on a larger scale, of the strip of pockets according to a first embodiment of the invention;

FIG. 3 is a sectioned side view, taken along the section line S-S in FIG. 1 and on a larger scale, of the strip of pockets according to a second embodiment of the invention;

FIG. 4 is a sectioned side view, taken along the section line S-S in FIG. 1 and on a larger scale, of the strip of pockets according to a third embodiment of the invention;

FIG. 5 is a face view of a sheet of insert cards, to the same scale as FIG. 1;

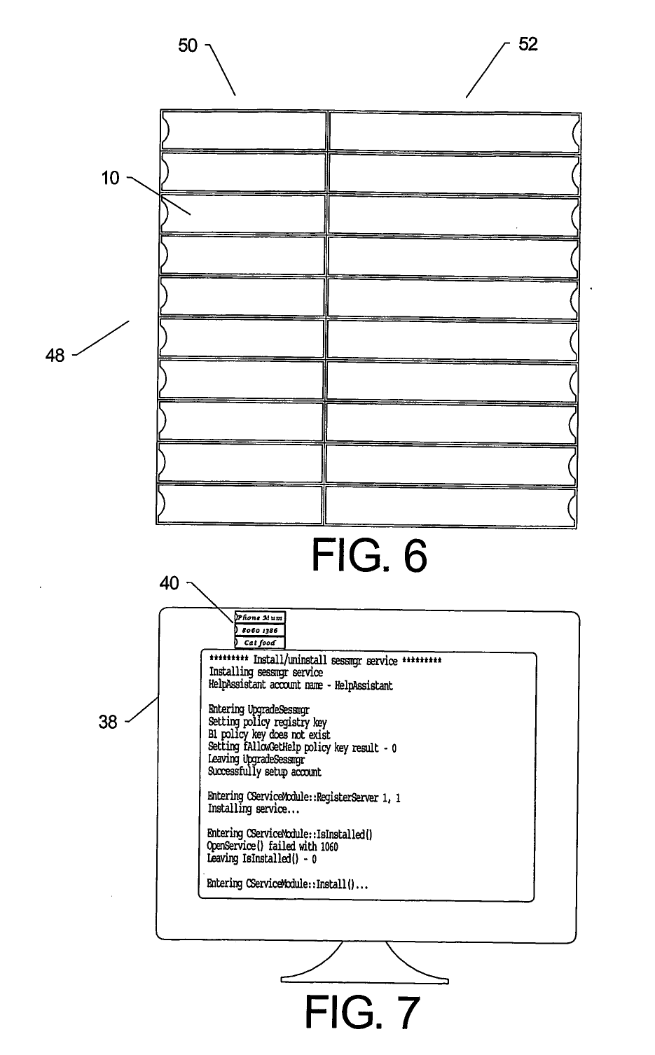

FIG. 6 is a face view of a sheet of pockets according to a fourth embodiment of the invention; and

FIG. 7 is a front view of a computer monitor to which a block of pockets has been applied.

Referring to FIGS. 1 and 2, in the first embodiment of the invention, a number of generally-rectangular pockets 10 are arranged, longer side by longer side, in a strip 12. Each pocket 12 has a front panel 14 of transparent, plastics material and a rear panel 16 of transparent or opaque, brittle, plastics material. The panels 14,16 of each pocket 10 are bonded or welded together along both of their longer edges 18 and along one 20 of their shorter edges, but not along their other shorter edges 22 so as to provide an opening into the pocket 10. Said other shorter edge 22 of the front panel 14 is formed with a cutaway 24 to facilitate removal of a piece of writing material 26 to be described later. The rear panels 16 are integrally formed in the strip 12 and have thinned portions or score lines 28 between each adjacent pair of pockets 10. The rear face of the strip of rear panels 16 is coated with a tearable adhesive layer 30 that has high adhesion to the rear faces of the rear panels 16 and moderate adhesion to the sorts of plastics materials from which the housings of computer monitors, telephones and the like are made. The rear face of the adhesive layer 30 is covered with a backing layer 32 of tearable material, such as paper, that has a release coating on its face in contact with the adhesive 30 so that the backing material can be readily peeled-off from the adhesive layer 30.

The strip 12 of pockets 10 is provided as a kit with a sheet 34 of material, such as card, as shown in FIG. 5 that can readily be written on by pen or pencil on at least one side, and preferably on both sides. The sheet 34 has a width W that is about the same as the internal length L of the pockets 10 and is divided by perforation, or micro-perforation, lines 36 having a spacing S that is slightly less that the internal height H of each pocket 10. The sheet 34 can therefore readily be divided up into a number of individual, rectangular insert cards 26 of a size W×S that will fit into the pockets 10.

In use, one of the pockets 10 is removed from the end of the strip 12 by snapping the strip of rear panels 16 along the appropriate score line 28 and then tearing the adhesive layer 30 and the backing later 32 along the same line. The portion of the backing layer 32 on the removed pocket 10 is then peeled off and thrown away, exposing the portion of the adhesive layer 30 on the rear of the pocket 10. The pocket 10 is then stuck, by the exposed adhesive layer 30, to any suitable surface. When it is desired to make a note of something, one of the insert cards 26 is torn off from the end of the sheet 34, and the note is written on one side of the insert card 26. The insert card 26 is then inserted into the pocket 10 so that the note can be seen through the transparent front panel 14 of the pocket 10. When the note is no longer needed, the insert card 26 can be removed from the pocket 10 by teasing it out with finger pad or fingernail in the cutaway 24, and if only one side of the insert card 26 has been used, a fresh note can be written on its reverse side. If it is desired to use a number of the pockets 10 next to each other, they can be removed from the strip 12 in a block, rather than individually, and, as shown in FIG. 7, stuck to a surface, such as the surround of a computer monitor 38, as a neatly aligned block 40.

The second embodiment of the invention will now be described with reference to FIG. 3. It is similar to the first embodiment described above with reference to FIGS. 1, 2, 5 and 7, except in the following respects. The rear panels 16 are again integrally formed in the strip 12, but they are of a tearable, rather than brittle, material, and there are lines of perforation holes 42 between the adjacent rear panels 16. Each pocket 10 has its own backing piece 44, rather than there being a continuous backing layer for the whole strip 12. Each backing piece 44 is of the same size W×S as the insert cards 26 described above. Although each backing piece 44 has a release coating on its face that is in contact with the adhesive, its other face can readily be written on by pen or pencil. Also, each pocket 10 has its own patch 46 of the adhesive layer, rather than there being a continuous adhesive layer for the whole strip 12. The size of each adhesive patch 46 is slightly less than the size of the size of the backing piece 44 so that each backing piece 44 completely covers its adhesive patch 46.

In use, one of the pockets 10 (or a block 40 of the pockets 10) is removed from the end of the strip 12 by tearing along the appropriate line of perforation holes 42. The backing piece(s) 44 is/are then carefully peeled-off from the pocket(s) 10, exposing the adhesive patch(es) 46 on the rear of the pocket(s) 10. The pocket 10 (or block 40 of pockets 10) is then stuck, by the exposed adhesive patch(es) 46, to any suitable surface. The backing piece(s) 44 can then be used as insert card(s) for the pocket(s) in a similar fashion to that described above in relation to the insert cards 26.

The third embodiment of the invention will now be described with reference to FIG. 4. It is similar to the first embodiment described above with reference to FIGS. 1, 2, 5 and 7, except in the following respects. The rear panels 16 are separately, rather than integrally, formed and need not be brittle. Each pocket 10 has its own patch 46 of the adhesive layer, rather than there being a continuous adhesive layer for the whole strip 12. The pockets 10 are held together in the strip 12 merely by being stuck to the continuous backing layer 32.

In use, one of the pockets 10 is removed from the end of the strip 12 either by peeling it off from the backing layer 32, or by tearing the backing layer 32 along the appropriate line and then peeling the torn-off portion of the backing layer 32 from the pocket 10. The pocket 10 is then stuck, by the exposed adhesive patch 46, to any suitable surface. If it is desired to use a number of the pockets 10 next to each other, preferably they are removed as a block 40 from the remainder of the strip 12 by tearing the backing layer 32 along the appropriate line so that the block 40 of pockets 10 remain connected and aligned by the torn-off portion of the backing layer 32. The backing layer 32 is then peeled-off sideways over about two-thirds of the length L of each pocket 10 so that the pockets 10 still remain connected and aligned by the portion of the backing layer 32 that has not yet been peeled-off. The block 40 of pockets 10 is then stuck to any suitable surface by the partially-exposed adhesive patches 46. The backing layer 32 is then completely removed by pulling it from between the block 40 of aligned pockets 10 and the surface.

In the fourth embodiment of the invention shown in FIG. 6, the pockets 10 are provided as a sheet 48 having a first column 50 of the pockets 10 of one length and a second column 52 of the pockets of a longer length. The sheet 48 may employ any of the techniques described above with reference to FIGS. 2 to 4 to hold the pockets 10 together.

In the embodiments of the invention described above, the portion of the front panel 14 of each pocket 10 through which the insert card 26,44 is viewed is transparent but may be coloured, textured and have a design applied around it, ranging from something basic for office users, to urban funky for cooler users, to cutesy for children, to technological for patent office examiners, glittery and starry for girls, etc. Although the pockets 10 and insert cards 26,44 have been shown as rectangular in the drawings, and although it is beneficial that the pockets and insert cards 26,44 have two parallel sides, they may be of any desired shape and size.

It should be noted that the embodiments of the invention have been described above purely by way of example and that many modifications and developments may be made thereto within the scope of the present invention.

1. An information display arrangement comprising a plurality of pockets (10), each pocket having a front panel (14) and a back panel (16), at least one edge (22) of each pocket being open so that a piece (26,44) of writing material can be inserted into that pocket, each front panel being sufficiently transparent to enable such a piece of writing material in the respective pocket to be seen through the front panel from the outside, the back panels being integrally formed with each other and held edge-to-edge in a strip with means defining lines (28;42) between adjacent pockets along which those pockets can be readily separated, the back panels being sufficiently brittle that they can readily be snapped apart along the separation lines, and the back of the strip being self-adhesive (at 30;46) to enable the pocket(s) separated from the strip to be adhered to a surface (38).

2-4. (canceled)

5. An information display arrangement as claimed in claim 1, and further including a continuous backing layer (32) covering the self-adhesive back of the strip, the backing layer being tearable along the separation lines and being peelable from the separated pocket(s) to expose the self-adhesive back(s) of the separated pocket(s).

6-9. (canceled)

10. An information display arrangement as claimed in claim 1, wherein the pockets are each generally rectangular and are arranged longer-edge to longer-edge in the strip.

11. An information display arrangement as claimed in claim 1, wherein the pockets are each generally rectangular with one of their shorter edges open.

12. An information display arrangement as claimed in claim 1, and further including a further such strip (52) held together with and readily separable from the first-mentioned strip (50).

13. An information display arrangement as claimed in claim 1, in combination with a plurality of pieces (26;44) of writing material, or a sheet (34) that can readily be divided up into a plurality of pieces of writing material, each of which can be written on and inserted into one of the pockets.

14. An information display arrangement comprising a plurality pockets (10), each pocket having a front panel (14) and a back panel (16), at least one edge (22) of each pocket being open so that a piece (26,44) of writing material can be inserted into that pocket, each front panel being sufficiently transparent to enable such a piece of writing material in the respective pocket to be seen through the front panel from the outside, the pockets being held edge-to-edge in a strip in such a way that one or more of the pockets can be readily separated from the remainder of the strip, the pockets being integrally formed with each other in the strip with means defining lines (28;42) between adjacent pockets along which those adjacent pockets can be readily separated, the back of the strip being self-adhesive (at 30;46) to enable the pocket(s) separated from the strip to be adhered to a surface (38) and the arrangement further including a series of backing pieces (44) each covering the self-adhesive back of a respective one of the pockets, each backing piece being peelable from the respective pocket to expose the self-adhesive back of the respective pocket.

15. An information display arrangement as claimed in claim 14, wherein each backing piece is a piece of writing material of a size such that it can be inserted into the respective pocket.

16. An information display arrangement as claimed in claim 14, wherein the strip is flexible and is readily tearable along the separation lines.

17. An information display arrangement as claimed in claim 14, wherein the back panels are integrally formed and are sufficiently brittle that they can readily be snapped apart along the separation lines.

18. An information display arrangement as claimed in claim 14, wherein the pockets are each generally rectangular and are arranged longer-edge to longer-edge in the strip.

19. An information display arrangement as claimed in claim 14, wherein the pockets are each generally rectangular with one of their shorter edges open.

20. An information display arrangement as claimed in claim 14, and further including a further such strip (52) held together with and readily separable from the first-mentioned strip (50).

21. An information display arrangement as claimed in claim 14, in combination with a plurality of pieces (26;44) of writing material, or a sheet (34) that can readily be divided up into a plurality of pieces of writing material, each of which can be written on and inserted into one of the pockets.
